(19) United States
(12) Patent Application Publication
(10) Pub. No.: US 2004/0102148 A1
(43) Pub. Date: May 27, 2004

(54) Coin separator and sorter assembly

(76) Inventors: Jerzy Perkitny, Lakewood, OH (US); William J. Knox JR., Painesville, OH (US)

Correspondence Address: Fay, Sharpe, Fagan, Minnich & McKee, LLP, 7th Floor, 1100 Superior Avenue, Cleveland, OH, 44114-2518, US

(21) Appl. No.: 10/633,756

(22) Filed: Aug. 4, 2003

Related U.S. Application Data
(63) Continuation-in-part of application No. 09/780,826, filed on Feb. 9, 2001.

(51) Int. Cl. G07D 3/00

(52) U.S. Cl. 453/13

(57) ABSTRACT

A coin bank includes a housing, a coin separating member, a coin sorting member on which the coin separating member is movably supported, and a metering tray supported adjacent the coin separating member. The coin separating member includes at least one coin receiving aperture. The coin sorting member includes at least one coin sorting aperture and is mounted to the housing. The metering tray is supported by the housing and regulates the number of associated coins delivered to the coin separating member.

This application is a continuation-in-part of application Ser. No. 09/780,826 filed on Feb. 9, 2002 which is still pending.

### BACKGROUND OF THE INVENTION

The present invention relates to coin banks. More particularly, the present invention relates to a very accurate coin separating and sorting assembly for a coin bank, the assembly being able to sort all of a country's or region's coins currently in widespread use. For the United States, such coins are the penny, nickel, dime, quarter and dollar coins.

Coin banks are generally known. A user places one or more coins in a hopper or similar coin receiving location. A coin separating mechanism separates the coins and moves them, hopefully one at a time, into a coin sorting mechanism. The coin sorting mechanism classifies the coins by their diameter. Coins of a particular diameter, and consequently of a particular denomination, are directed into the appropriate one of a plurality of sorted coin storage containers.

Coin separating mechanisms employing rotating coin separator plates are known. One known such separator plate is in the form of a disk having four U-shaped notches formed in its periphery. Each notch is sized to be larger in width than the largest coin which is to be sorted by the coin sorter. The separator plate is mounted on a planar base of a receiver, the base being fixed to an upper housing at a slope of approximately 45° from the horizontal. Coins tend to come to rest in the lowermost portion of the receiver with their faces contacting the separator plate or the base. When the separator plate is rotated, it will engage a coin with the edge of one of its notches and carry it upward to an opening formed in the base where the coin will fall through into an upper portion of a coin ramp leading to the sorting ramp. The ramp has apertures of increasing size through which the coins fall into sorted coin containers. The thickness of the sorter plate is chosen to be less than or equal to the thickness of the thinnest coin to be sorted so that only one coin at a time is engaged by each notch. However, this known coin separating mechanism does not employ a separator plate which delivers pre-oriented coins to a sorter. Nor does it perform its separating and sorting functions in a minimum of space. Also this known coin separating mechanism is not designed to handle dollar coins. Furthermore, this known coin separating mechanism does not regulate the number of coins that are delivered to the separator plate to reduce the likelihood of jamming the coin separating mechanism.

Accordingly, it is desirable to develop a new and improved coin separator and sorter assembly which would overcome the foregoing deficiencies and others as well as providing better and more advantageous overall results. Furthermore, it is desirable to provide this coin separator and sorter assembly as a part of a coin bank.

### BRIEF SUMMARY OF THE INVENTION

According to one aspect of the present invention, a coin bank is provided.

More particularly, in accordance with this aspect of the invention, the coin bank comprises a housing, a coin separating member, a coin sorting member on which the coin separating member is movably supported, and a metering tray supported adjacent the coin separating member. The coin separating member includes at least one coin receiving aperture. The coin sorting member includes at least one coin sorting aperture and is mounted to the housing. The metering tray is supported by the housing and regulates the number of associated coins delivered to the coin separating member.

According to another aspect of the present invention, a coin bank is provided.

More particularly, in accordance with this aspect of the invention, the coin bank includes a housing, a coin separating member, a coin sorting member on which the coin separating member is supported, a coin slide, and a coin metering tray. The coin separating member includes at least one coin receiving aperture. The coin sorting member is mounted to the housing and includes at least one coin sorting aperture. The coin slide is mounted to the housing below the coin sorting member. The coin metering tray is mounted to the housing above the coin sorting member. The coin metering tray includes walls and an opening which limits the number of associated coins passing from the tray to the coin separating member.

According to another aspect of the present invention, a metering tray for metering the number of associated coins delivered to a coin separating member of a coin bank is provided. The tray includes a plurality of walls defining an opening that limits the number of the associated coins exiting the tray at any given time.

According to another aspect of the present invention, a coin separating and assorting assembly is provided.

More particularly, in accordance with this aspect of the invention, the assembly comprises a separating wheel including at least one coin receiving aperture and a wheel housing on which the separating wheel is supported. The separating wheel also includes a toroidal flange extending away from a face of the separating wheel and a protuberance on the toroidal flange near the at least on coin receiving aperture.

In accordance with still another aspect of the present invention, a coin metering tray is provided.

More particularly in accordance with this aspect of the present invention, the coin metering tray comprises a first side wall, a second side wall spaced from the first side wall, a first end wall connecting the first and second side walls, a floor extending between, and connected to, the first end wall and the second side wall, an aperture defined in the floor, a ramp extending between and connected to the floor and the first side wall, and a blocking wall. The blocking wall is connected to a first side edge of the ramp and to the first side wall. The blocking wall prevents associated coins in the tray from sliding off the ramp and into the aperture.

### BRIEF DESCRIPTION OF THE DRAWINGS

The invention may take form in certain components and structures, several embodiments of which will be illustrated in the accompanying drawings and wherein:

FIG. 1A is an exploded perspective view of a first portion of a coin bank according to a first embodiment of the present invention;

FIG. 1B is an exploded perspective view of a second portion of the coin bank according to the first embodiment of the present invention;

FIG. 1C is an exploded perspective view of a third portion of the coin bank according to the first embodiment of the present invention;

FIG. 2 is an enlarged perspective view from a top side of a separating wheel of the coin bank of FIG. 1;

FIG. 3 is an enlarged perspective view from a top side of a wheel housing of the coin bank of FIG. 1;

FIG. 4 is an assembled top plan view of a coin separating and sorting assembly of the coin bank of FIGS. 1A and 1B;

FIG. 5 is a cross-sectional view along line 5-5 of the coin separating and sorting assembly of FIG. 4;

FIG. 5A is an enlarged view of a portion of the coin separating and sorting assembly of FIG. 5;

FIG. 6 is an enlarged cross-sectional view along line 6-6 of the coin separating and sorting assembly of FIG. 4;

FIG. 7 is a greatly enlarged partial bottom plan view of the separating and sorting assembly of FIG. 6 with parts removed for clarity;

FIG. 8 is an enlarged top plan view of a coin slide of the coin bank of FIG. 1B;

FIG. 9 is an exploded perspective view of a first portion of a coin bank according to a second embodiment of the present invention;

FIG. 10 is a top plan view of a coin separating member of the coin bank of FIG. 9;

FIG. 11 is a top plan view of a coin sorting member of the coin bank of FIG. 9;

FIG. 12 is an assembled top plan view of a coin separating and sorting members FIGS. 10 and 11 and a coin metering tray;

FIG. 13 is a cross-sectional view along line 13-13 of the coin separating and sorting assembly of FIG. 12;

FIG. 14 is an enlarged top perspective view of the coin metering tray of FIG. 9;

FIG. 15 is a top plan view of the coin metering tray of FIG. 14;

FIG. 16 is a bottom plan view of the coin metering tray of FIG. 14;

FIG. 17 is an assembled front perspective view of the coin separating and sorting assembly of FIG. 9;

FIG. 18 is a rear perspective view of the coin separating and sorting assembly of FIG. 17;

FIG. 19 is a top plan view of the coin separating and sorting assembly of FIG. 17; and

FIG. 20 is a cross-sectional view along line 20-20 of the coin separating and sorting assembly of FIG. 19.

### DETAILED DESCRIPTION OF THE SEVERAL EMBODIMENTS

Referring now to the drawings, wherein the showings are for purposes of illustrating several embodiments of the invention only and not for purposes of limiting same, the Figures show a coin separating and sorting assembly as employed in one type of coin bank. Of course, it should be appreciated that the coin separating and sorting assembly could be used in a variety of different coin banks.

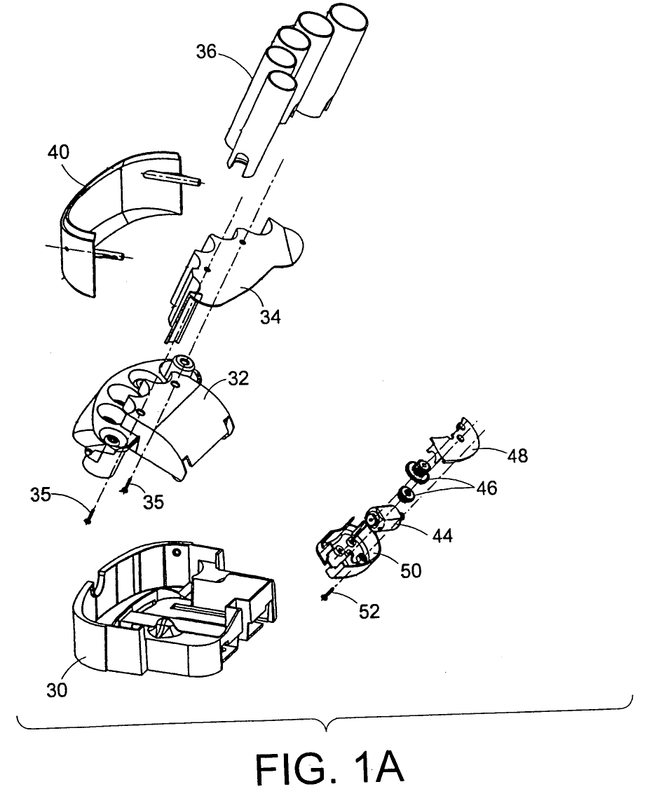

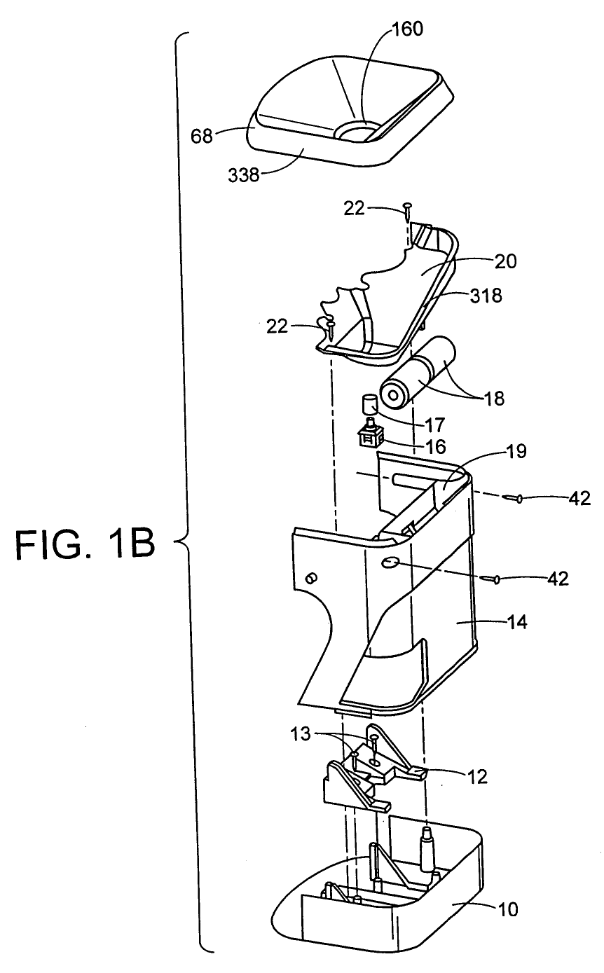

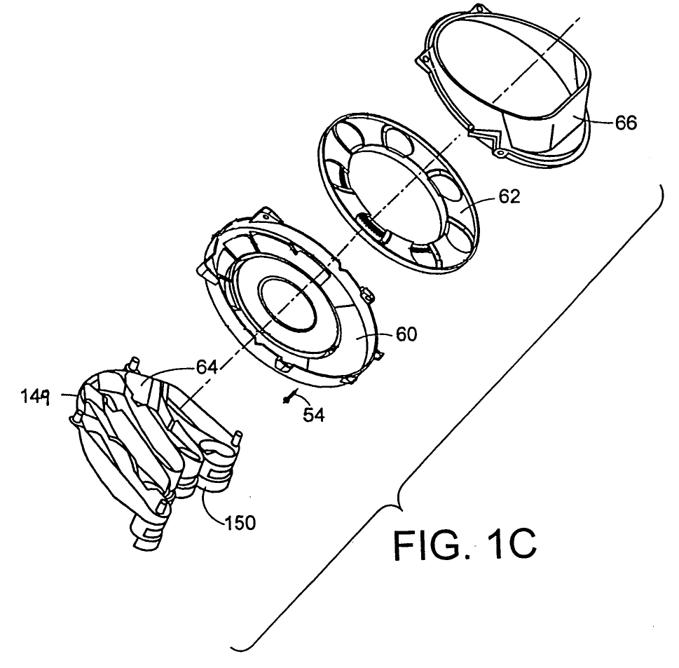

With reference now to FIG. 1B, the coin bank according to the present invention comprises a base 10 on which is positioned a ramp 12. The ramp can be secured to the base by suitable fasteners 13. Mounted on the base 10 is a back housing 14. Secured to the back housing is a switch 16, to which is connected an activation button 17. One or more batteries 18 can be mounted in a battery housing compartment 19 formed in the back housing 14. A coin overflow compartment 20 can be mounted on the base 10 via suitable fasteners 22.

With reference now also to FIG. 1A, slidably mounted in the base 10 is a drawer 30. Housed in the drawer 30 is a coin tube base 32 having a rear support wall 34 which is secured to the coin tube base 32 by suitable fasteners 35. Several coin tubes 36, one for each denomination of coins meant to be sorted, are selectively mounted on the coin tube base 32 and are supported by the support wall 34 which has suitably shaped indentations for that purpose. A front wall 40 of the apparatus is mounted to the back housing 14 by S suitable fasteners 42 (FIG. 1B). The front wall 40 is located above the drawer 30 and is spaced therefrom by the length of the coin tubes 36. A motor 44 of the apparatus has an output shaft (not visible in FIG. 1A) connected to a gear train having a plurality of gears 46. The motor 44 and the gears 46 are mounted in a housing assembly having an upper housing portion 48 and a lower housing portion 50, which are secured together by a fastener 52.

With reference now also to FIG. 1C, suitable fasteners 54 are employed to mount a wheel housing 60 in place in the apparatus. The motor housing halves 48 and 50 are secured by the fastener 52 to a lower face of the wheel housing 60. Mounted on the wheel housing 60 is a separating wheel 62. With reference again to FIG. 1C, positioned beneath the wheel housing 60 and mounted thereto is a coin slide 64. A cover or hopper 66 is mounted above the wheel housing 60. A funnel 68 (FIG. 1B) constitutes a top portion of the coin bank. The funnel is selectively removable from the coin bank to provide access to the separating wheel 62.

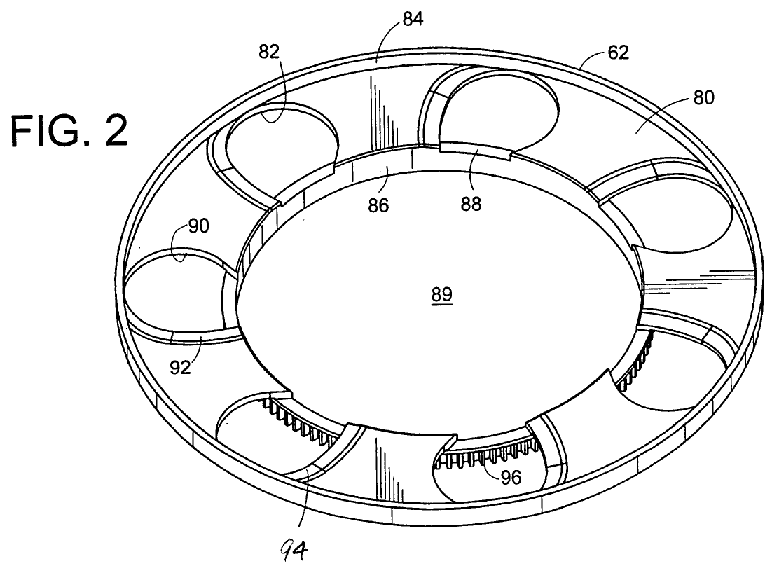

With reference now to FIG. 2, the coin separating wheel 62 is toroidal or ring-like and includes a top wall 80 having a plurality of spaced apertures 82 located therein. Each of the apertures extends from an inner periphery of the ring-like sorting wheel 62 to an outer flange 84 thereof. Also provided is an inner flange 86 which depends from the inner periphery of the top wall 80. A set of slots 88 are located in the inner flange 86, each slot opening to a respective one of the apertures 82. The inner flange 86 surrounds an open center portion 89 of the separating wheel. Each of the apertures 82 includes a leading edge 90 and a trailing edge 92. The trailing edge has a tapered surface 94. Provided on an outer surface of the inner flange 86 is a set of gear teeth 96.

Each aperture 82 is sized so as to accommodate the largest diameter coin meant to be sorted. If the coins are United States coins, the largest diameter coin meant to be sorted in the coin sorting apparatus is a Sacajawea or Susan B. Anthony dollar. The thickness of the top wall 80 is greater than the thickness of the thickest coin meant to be sorted. In United States coinage the largest diameter coin is also the thickest coin, the dollar coin.

The reason why the leading edge of each aperture 82 is thicker than the thickness of the thickest coin being sorted is that it is undesirable if a coin held in the aperture 82 picks up another coin during sorting simply because a top surface of the coin extends out of the aperture. In other words, if the thickest coin being sorted were thicker than is the thickness of the top wall 80, such thicker coin could pick up another coin thereby causing a missorting as the coin would itself act as a picker element, which is meant to be function of the separating wheel.

The trailing edge 92 of each aperture 82 is thinner than is the thickness of the thinnest coin meant to be sorted. If the coin sorter is meant to sort United States coinage, then that coin would be a dime. The size of the aperture 82 is smaller than two such smallest diameter coins positioned side by side. In other words, the apertures 82 will not accommodate two such coins 104 in a side by side manner. Rather, one of the coins will project out of the aperture.

It should be apparent from FIG. 2 that the shape of the apertures 82 is asymmetrical. In other words, each aperture 82 is more curved at its leading edge 90 than it is at its trailing edge 92. The more circular leading edge insures that while the aperture is large enough to accommodate the largest diameter coin meant to be sorted, it is not so large as to hold two of even the smallest diameter coins meant to be sorted. Also, the aperture is of suitable dimensions as to cause an inner portion of the largest diameter coin meant to be sorted to protrude through the slot 88.

The coins are urged by gravity radially inwardly during rotation of the wheel, due to the shape of the aperture 82 and the angle at which the separator wheel 62 is mounted, before the coins reach the first aperture in the wheel housing. In other words, the angle at which the separator wheel 62 and wheel housing 60 are oriented in relation to a horizontal plane is large enough to overcome the force of friction and allow the coins to slide radially inwardly on the wheel housing. That angle may be approximately 45°. Configuration of the trailing edge 92 is important in allowing coins to move radially inwardly during rotation of the wheel before the coins reach the first wheel housing aperture.

The radially outermost point of each separator wheel aperture 82 is even with the outer flange 84 and no wall section is located between them. This construction prevents coins at the lowest point of the coin sorter during rotation of the wheel in relation to the wheel housing from getting hung up and not falling completely into an aperture 82. Such a wall section would prevent the coins from being successfully sorted.

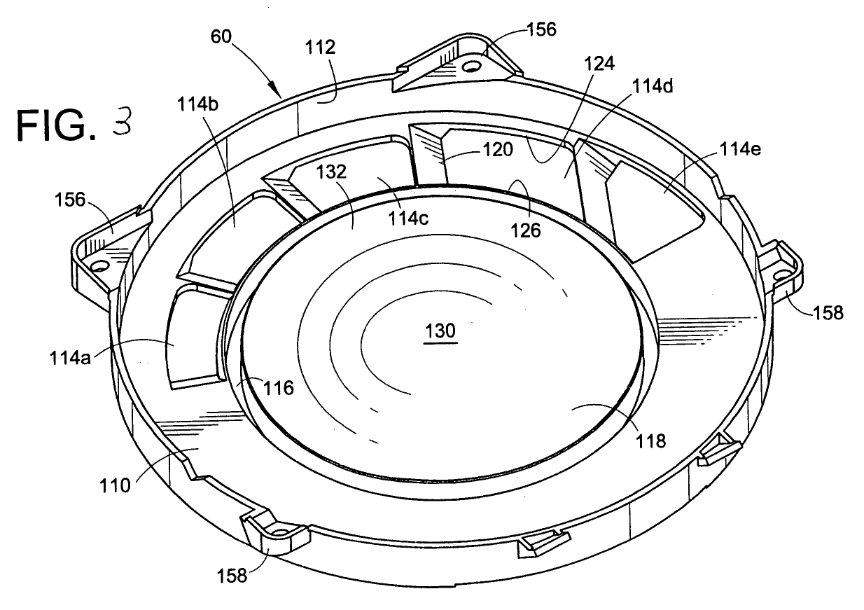

With reference now to FIG. 3, the wheel housing 60 comprises an outer wall 110 having an outer skirt 112. Located radially inwardly from the skirt 112 are a series of spaced apertures 114. It is apparent that the apertures are of different sizes such that the apertures increase in width clockwise from a smallest width aperture 114a to a largest width aperture 114e. Positioned radially inwardly from the set of apertures 114 is a channel shaped groove 116. It is apparent that the groove 116 is ring-like in nature. The groove 116 surrounds a central wall portion 118 of the wheel housing. Each of the apertures 114 can be defined by a tapered rear wall 120 as well as an outer edge 124 and an inner edge 126. While the inner edges 126 for each of the apertures 114 remain at the same radial distance from an axis of the wheel housing 60, the outer edges 124 of the apertures are at a progressively greater distance from the axis of the wheel housing, increasing in a clockwise manner. This allows the apertures to accommodate increasingly larger diameter coins from a smallest diameter coin meant to be sorted being accommodated in aperture 114a to a largest diameter coin meant to be sorted being accommodated in aperture 114e.

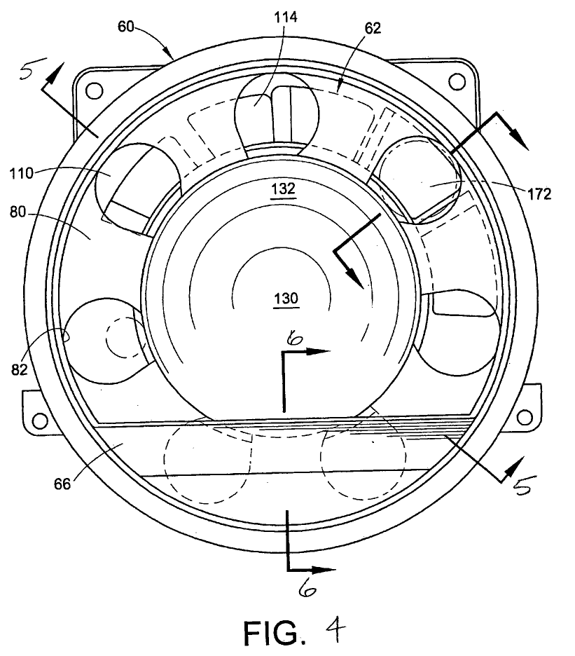

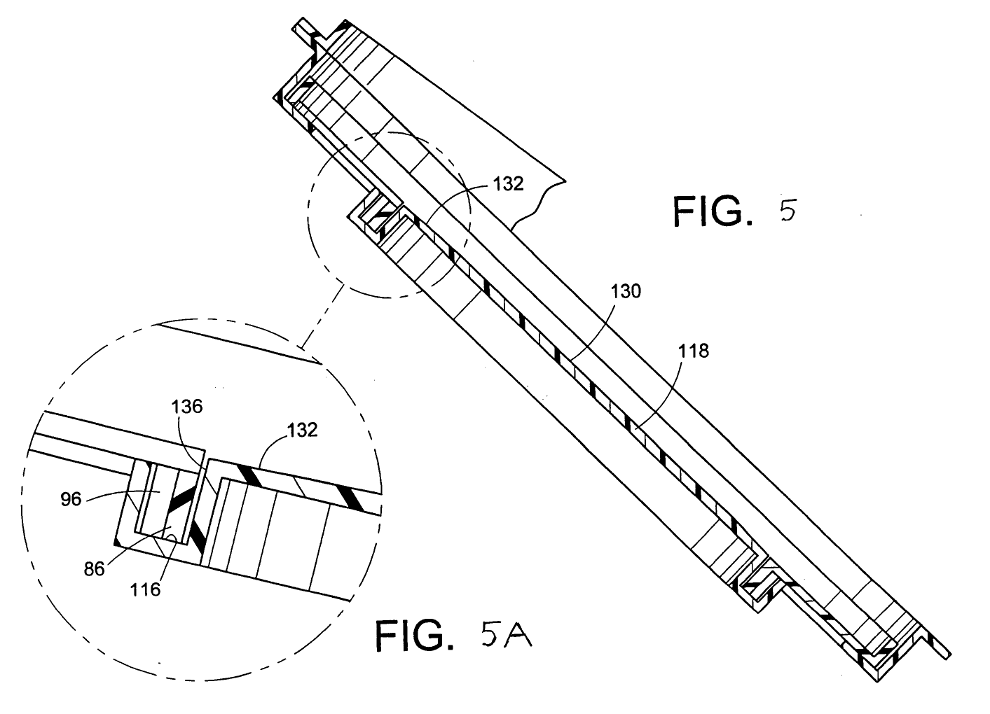

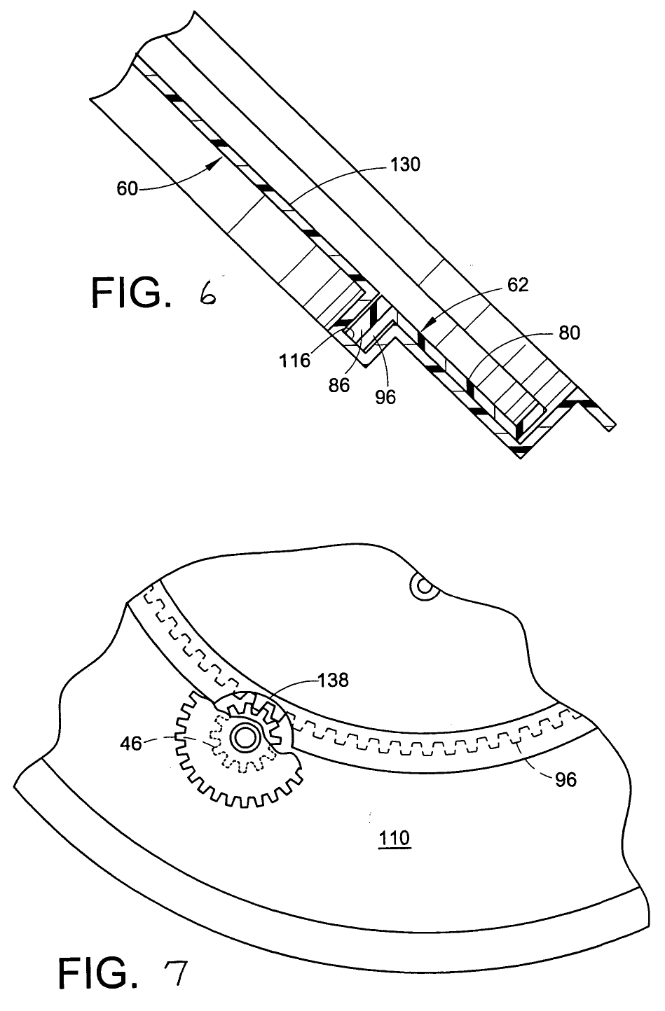

With reference now to FIG. 5, it should be appreciated that the central wall portion 118 is a plateau 130 with a somewhat C-shaped recessed area 132. The purpose for the recessed area is to allow coins not fitting in an aperture 82 to slide down, due to gravity, toward a lower portion of the wheel housing 60. It should be apparent from FIG. 5 that the central wall portion 118 is at a higher elevation than is the outer wall portion 110. Thus except for the recessed area 132, the plateau 130 of the central wall portion 118 lies at the same elevation as the top surface of the separating wheel 62 which is accommodated in the wheel housing 60. This can be seen from FIG. 6. In contrast, the C-shaped recessed area 132 of the central wall portion 118 is at the same elevation as the wheel housing in an area where there is an aperture 82 extending through the separating wheel 62. This can be seen from FIG. 5A.

The difference in height between the central wall portion 118 and the outer wall 110 of the wheel housing defines a stationary rolling surface 136 against which an edge of a coin being sorted rolls as the coin is moved by the separating wheel 62 in a clockwise manner on the wheel housing until the coin falls through the aperture 114 designed to accommodate it. The rolling surface 136 has a width which is thinner than a thickness of the thinnest coin meant to be sorted.

As mentioned previously, the straighter trailing edge 92 of the separating wheel aperture 82 enables smaller coins, once they are picked up, to travel radially inwardly, i.e. centripetally, due to gravity so as to protrude through the slot 88 to the greatest extent possible. This enables the smaller coins to be sorted correctly. Forcing smaller coins to move centripetally establishes a relationship between a radially inner point of a coin, the sorting surface, namely the outer edge 124 of the aperture 114, and the stationary rolling surface 136.

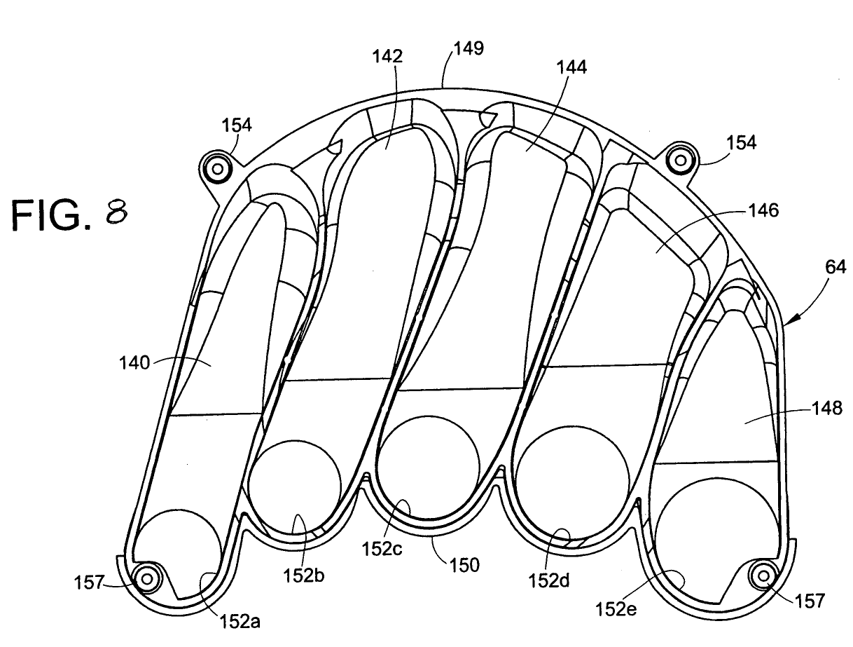

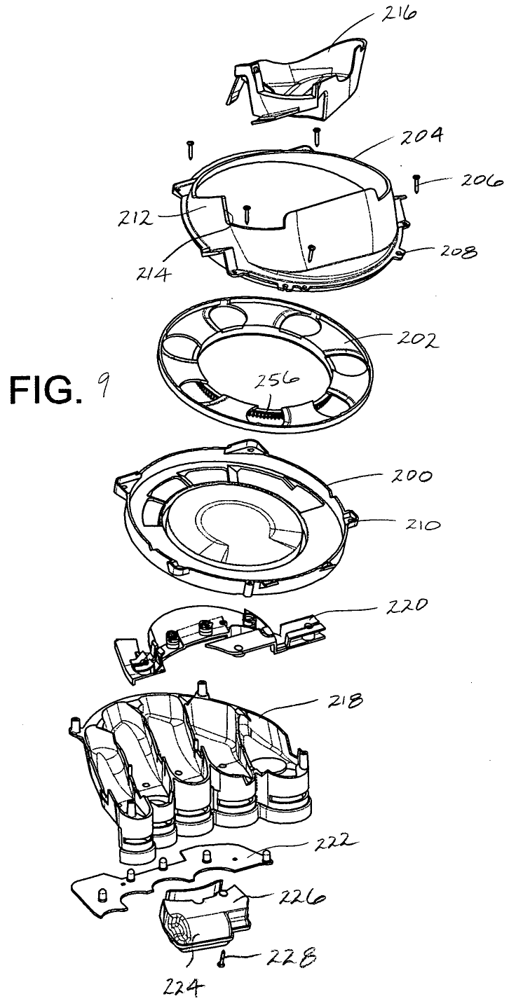

With reference now to FIG. 7, it can be seen that a slot 138 is located in the wheel housing 60. The slot enables a suitable one of the gears 46 to contact the gearing 96 of the separating wheel 62 in order to allow the separating wheel to be rotated when the separating wheel is mounted in the wheel housing 60. While gearing 96 is illustrated for the sorting wheel 60, it should be appreciated that the sorting wheel could also be rotated by other means, such as via a belt or a similar known arrangement.

With reference now to FIG. 8, the coin slide 64 is provided with five coin sliding surfaces 140-148. Each of the coin sliding surfaces is positioned beneath a respective one of the openings 114a-114e. The coin slide slopes from an upper end 149 to a lower end 150. Positioned at a lower end of each of the coin sliding surfaces 140-148 is a respective opening 152a-152e. It should be apparent that the several openings 152a-152e are of differing diameters, with the aperture 152a having the smallest diameter and the aperture 152e having the largest diameter. The diameters of the apertures 152a-152e are each slightly larger than the diameter of the coin meant to be accommodated in a respective one of the slides. The diameters of the apertures 152a-152e correspond with the widths of the openings 114a-114e in the wheel housing 60.

A pair of spaced ears 154 are located on the upper end 149 of the coin slide 64. These ears 154 cooperate with suitable ears 156 (FIG. 3) extending away from the skirt 112 of the wheel housing 60. Similarly, spaced posts 157 extend away from the lower end 150 of the coin slide adjacent the smallest and largest diameter apertures 152a and 152e. The posts 157 cooperate with ears 158 (FIG. 3) extending away from the skirt 112 of the wheel housing 60. Suitable fasteners, not illustrated, enable the coin slide 64 to be mounted beneath the wheel housing 60 via the cooperating ears 154 and 156 and the cooperating posts 157 and ears 158. Note that a center portion of the coin slide lower end 150 is somewhat recessed in relation to the two wings thereof to form a somewhat crescent shaped lower end 150. This shape allows the motor housing 48, 50 to be secured to the wheel housing while not interfering with the coin slide 64.

A coin can be positioned in an aperture 82 of the sorting wheel 62. The coin abuts the rolling surface 136 of the wheel housing 60. The coin is supported along its radially inner portion by the flange 86 of the sorting wheel. However, the coin cannot fall through the aperture 114 because it has a diameter larger than the diameter of the aperture.

The separating wheel 62 and the wheel housing 60, as well as the coin slide 64, can be manufactured from a suitable conventional plastic material. Alternatively, they can be made of a suitable conventional metal.

The operation of the coin sorter according to the present invention is as follows. As coins are dropped into the funnel 68, they will fall through an aperture 160 at the center thereof and fall into the hopper 66 and onto the sorting wheel 62. As the motor 44 rotates the gears 46 in the gear train, the gears will engage the gearing 96 on the separating wheel 62 causing it to begin rotating in a clockwise direction. The coins thus being held in the cover or hopper 66 are moved and fall into respective ones of the apertures 82 in the separating wheel 62. As the wheel 60 rotates on the canted wheel housing 62, coins will slide radially inwardly in the apertures 82, due to gravity as a result of the angle at which the coin separator wheel is positioned in relation to a vertical axis, and contact the rolling surface 136. The coins will roll against this surface as the wheel 62 rotates and moves the coins over the wheel housing 60. As a coin held in an aperture 82 of the wheel travels over the several increasingly larger sized apertures 114a-114e in the wheel housing 60, the coin will fall through the correctly sized opening. The coin will fall into the associated one of the coin sliding surfaces 140-148. The coin will then travel down the slide and fall through the associated one of the apertures 152a-152e. Coins will thereafter fall into a respective one of the coin containers 36 and be stacked therein.

While the wheel housing 60 and separating wheel 62 are illustrated as being used in connection with a coin slide 64 and a coin sorter mechanism as shown in FIGS. 1A and 1B, it should be appreciated that the wheel housing and sorting wheel disclosed herein can be used in a large variety of other types of coin sorters having much different types of coin slides and coin receiving areas, not to mention means for storing the coins or dispensing the coins as may be required.

With reference now to FIG. 9, according to another embodiment a coin sorting and separating mechanism for a coin bank is provided. A coin sorting member 200, which in this particular embodiment is a wheel-shaped housing, supports a coin separating member 202. The coin separating member 202 in this embodiment is also wheel-shaped.

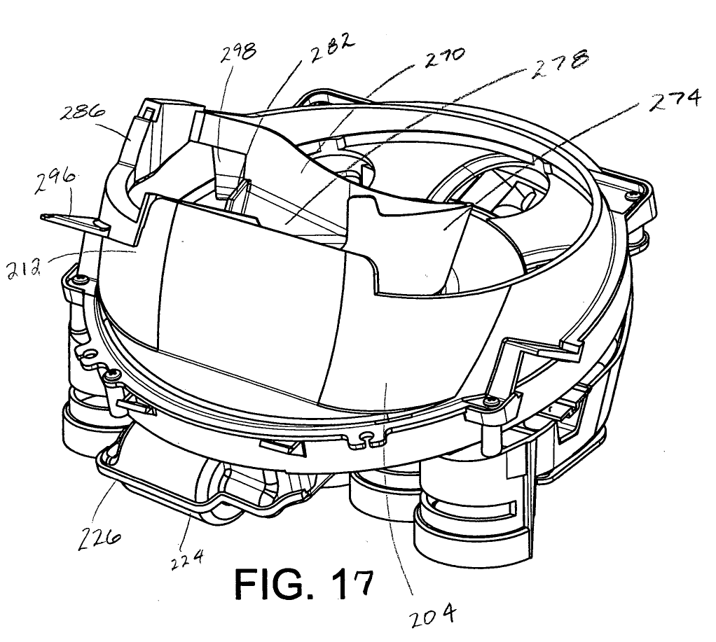

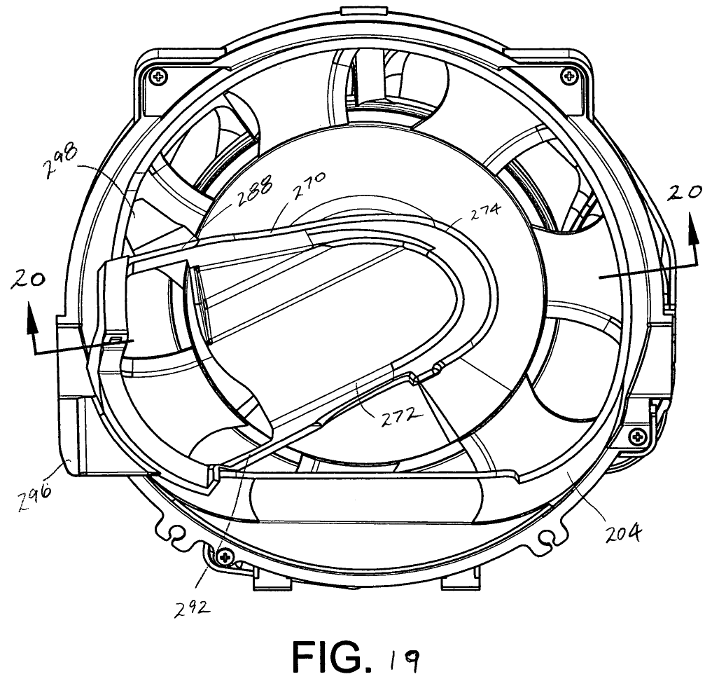

The coin sorting member 200 in the embodiment depicted in FIG. 9 is similar to the wheel housing 60 depicted in FIG. 1C, however the coin sorting member can take other shapes and should not be limited to a wheel shaped configuration. Nevertheless, for ease of understanding the embodiment depicted in FIGS. 9-20, the coin sorting member will be referred to as the wheel housing. Such a referral should not be deemed to limit the invention to a wheel-shaped coin sorting member. Likewise, the coin separating member 202 is similar to the separating wheel 60 depicted in FIG. 1C, however the coin separating member can take other shapes. Similar to the wheel housing, for ease of understanding only, the coin separating member will be referred to as a coin separating wheel.

A coin hopper 204 mounts to the wheel housing 200. Suitable fasteners 206 extend through holes in tabs 208 in the coin hopper 204 and align with holes in tabs 210 in the wheel housing 200. The coin hopper 204 has a peripheral wall 212 that includes a notch 214. A portion of a coin metering tray 216 is received within the notch 214 so that the hopper 204 supports a portion of the coin metering tray.

A coin slide 218 is disposed below the wheel housing 200. The coin slide 218 is similar in design to the coin slide 64 depicted in FIG. 1C. A first or transmission portion 220 of a coin counting sensor can be interposed between the wheel housing 200 and the coin slide 218. A second or receiver portion 222 of a coin counting sensor is positioned below the coin slide. The two portions cooperate to count the number of coins falling from the wheel housing 200 onto the coin slide 218. A motor 224 held in a housing 226 mounts to an underside of the coin slide 218 by use of conventional fasteners 228. The motor 224, through a transmission (not shown), rotates the separating wheel 202.

Referring to FIG. 10, the wheel housing 200 includes a base wall 230 having an outer skirt 232. Located radially inwardly from the skirt 232 are a series of spaced apertures 234. It is apparent that the apertures are of different sizes such that the apertures increase in width clockwise from a smallest width aperture 234a to a largest width aperture 234e. Positioned radially inwardly from the set of apertures 234 is a channel shaped groove 236. The groove 236 is ring-like in nature. The groove 236 surrounds a central wall portion 238 of the wheel housing. Many of the apertures 234 can be defined by a tapered rear wall 240. Each aperture has an outer edge 242 and an inner edge 244. While the inner edges 244 for each of the apertures 234 remain at the same radial distance from an axis of the wheel housing 200, the outer edges 242 of the apertures are at a progressively greater distance from the axis of the wheel housing, increasing in a clockwise manner. This allows the apertures to accommodate increasingly larger diameter coins from a smallest diameter coin meant to be sorted being accommodated in aperture 234a to a largest diameter coin meant to be sorted being accommodated in aperture 234e.

As can be seen in FIG. 10, apertures 234d and 234e are not separated by a rear wall. The outer edge 242 of aperture 234e is simply farther away from the inner edge 244 than the outer edge 242 of the aperture 234d. Apertures 234d and 234e can be viewed as one aperture having a first width that is sized to allow passage of a first diameter coin, which in the case of U.S. coinage would be the quarter, and having a second width that is sized to allow passage of a larger diameter coin, which in the case of U.S. coinage would be the dollar coin. A rear ramp 246 is located along the outer edge 242 between aperture 234d and 234e. The ramp 246 is tapered similarly to tapered walls 240.

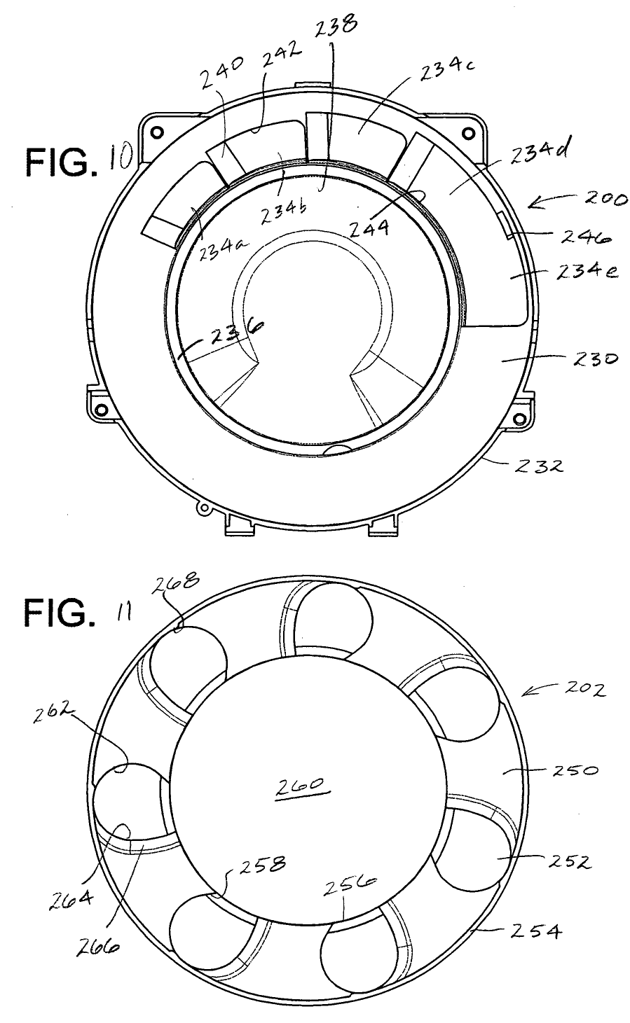

With reference now to FIG. 11, the coin separating wheel 202 is toroidal or ring-like and includes a top wall 250 having a plurality of spaced apertures 252 similar to the coin separating wheel 60 described with reference to FIGS. 1-8. Each of the apertures extends from an inner periphery of the separating wheel 252 to an outer flange 254 thereof. Also provided is an inner flange 256 that depends from the inner periphery of the top wall 250. This embodiment includes slots 258 located in the inner flange 256, each slot opening to a respective one of the apertures 252. The inner flange 256 surrounds an open center portion 260 of the separating wheel. Each of the apertures 252 includes a leading edge 262 and a trailing edge 264 similar to the separating wheel 60 described above. The trailing edge has a tapered surface 266.

In this embodiment, a protuberance 268 on the outer flange 254 is located adjacent each aperture 252. The protuberance 268 extends radially inwardly from the outer flange 254 towards the leading edge 262 of the aperture 252. The protuberance 268 follows the radius of the leading edge 262 and can help urge a coin into the aperture 252 and towards the slot 258.

With reference now to FIG. 12, an embodiment of the metering tray 216 will be more particularly described. The metering tray regulates the number of coins that are delivered to the coin separating wheel 202 to reduce the likelihood of jamming the separating wheel 202 as it rotates. The metering tray can be made of a thermoplastic and be of a unitary construction. Alternatively, the tray can be made of another suitable durable material and from a plurality of components. The metering tray described in the succeeding figures is but one embodiment of a tray that can meter the number of coins delivered to the coin separating and sorting mechanism.

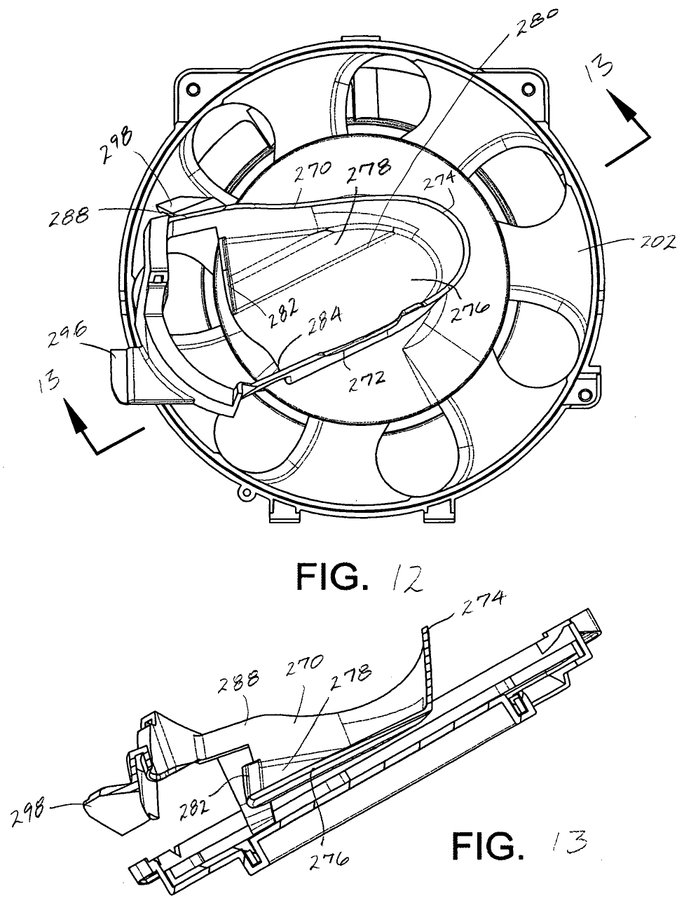

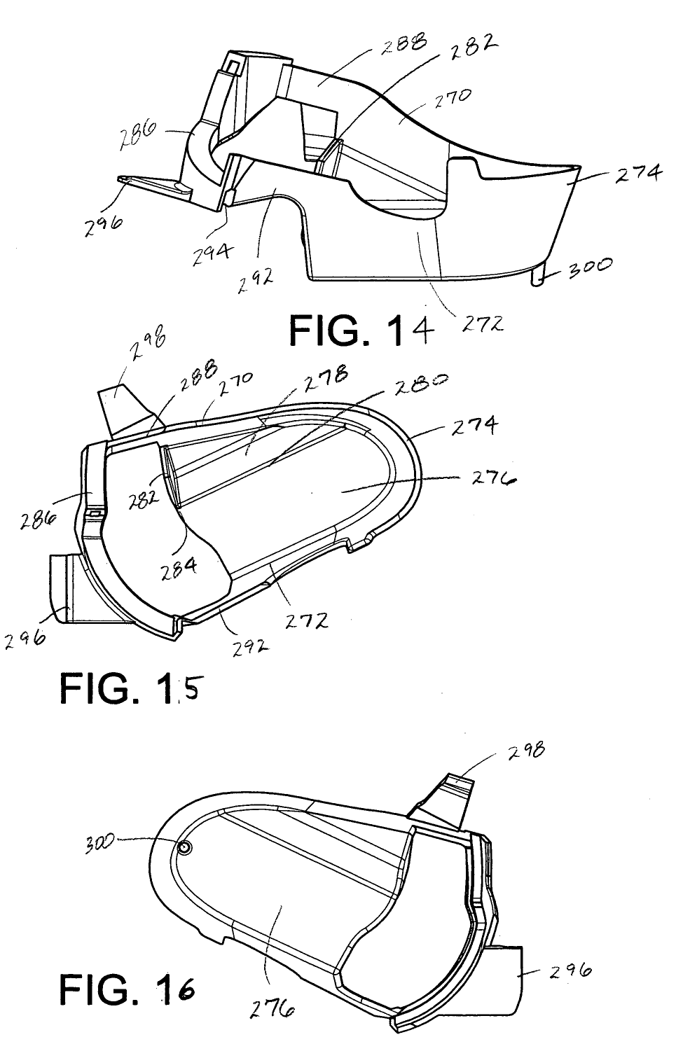

In this embodiment, the metering tray includes a first side wall 270 and a second side wall 272 spaced from the first side wall. A first end wall 274 connects the first side wall 270 to the second side wall 272. In this embodiment, the first and second side walls 270, 272 are generally linear in top plan view and the first end wall 274 is generally curved in top plan view. Therefore, in this embodiment, if considering the walls 270, 272 and 274 as one continuous wall, that wall would have a substantially parabolic shape in top plan view. As apparent in FIGS. 13 and 14, the walls 270, 272 and 274 have a height that allows the walls to retain several coins stacked upon one another inside the walls.

The metering tray can also include a floor 276 extending between and connected to the walls. A ramp 278 extends between and is connected to the floor 276 and the first side wall 270. The ramp 278 slopes downwardly from the first side wall 270 towards the floor 276. The ramp 278 is shaped such that its lower edge 280 is substantially parallel with the second side wall 272. By having such a configuration, the ramp 278 is longer away from the first end wall 274 and gets shorter towards the first end wall.

A blocking wall 282 projects upwardly from the ramp 278 on an edge of the ramp opposite the first end wall 276. The wall 282 extends from the first side wall 270 towards the floor 276. The wall 282 can block coins that fall on the ramp 278 from sliding directly off the ramp and onto the coin separating wheel 202. Together, the blocking wall 282, the floor 276 and the second side wall 272 define an opening 284.

The opening 284 allows coins to pass from the metering tray 216 to the coin separating and sorting mechanism. More specific to this embodiment, the opening 284 in the metering tray 216 allows coins to pass from the tray 216 onto the separating wheel 202. The opening 284, in this embodiment, has a width that is wide enough to accomodate the largest coin meant to be sorted through the opening, but small enough to preclude two of the smallest diameter coins meant to be sorted from passing through the opening side by side. Furthermore, as is apparent in FIG. 12, the floor 276 can have a width that is equal to the width of the opening 284. In this manner, the floor can act as a sort of chute that facilitates delivery of coins to the opening in a metered fashion.

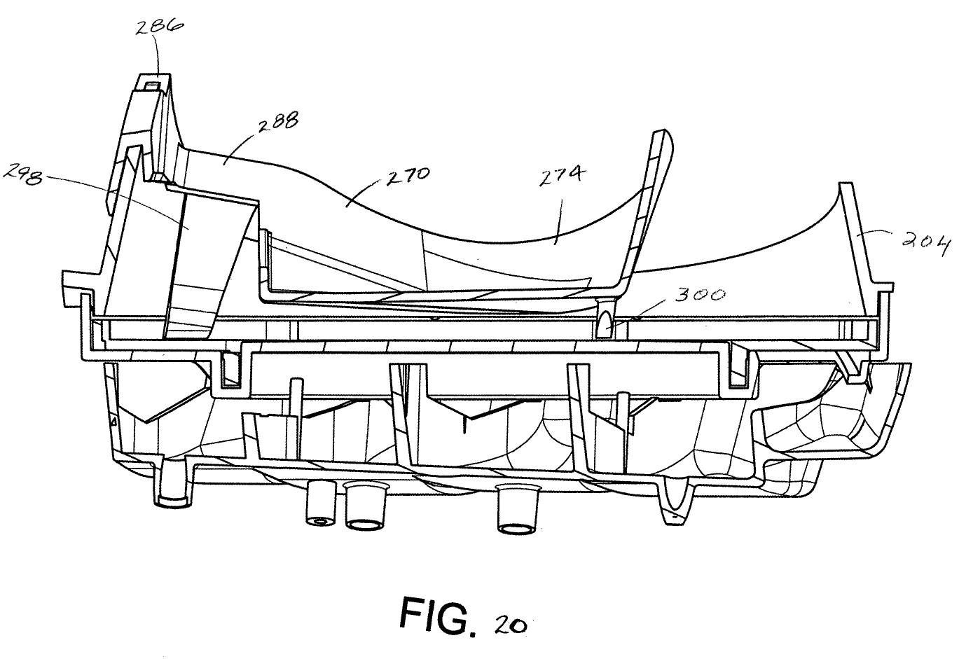

With reference also now to FIG. 14, the metering tray also includes a second end wall 286 secured to the first side wall 270 and the second side wall 272. The second end wall 286 can be defined as a downwardly opening channel 294 that is seated on a portion of the outer wall 212 of the hopper 204, as best shown in FIG. 20.

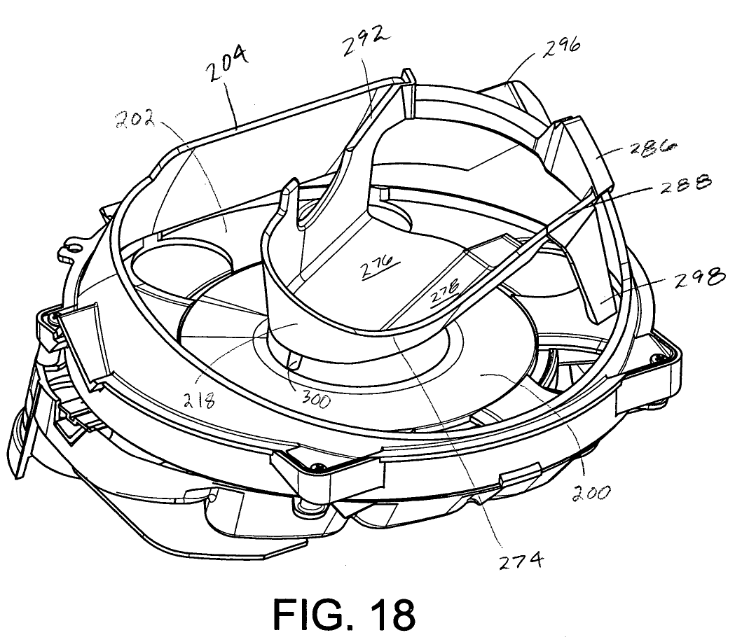

In this particular embodiment, a first extension 288 leads from the first side wall 270 and connects to the second end wall 286. Furthermore, a second extension 292 leads from the second side wall 272 and connects to the second end wall 286. The extensions 288 and 292 project from an upper portion of their respective side walls 270 and 272. As perhaps best shown in FIG. 18, the extensions 288 and 292 extend over the separating wheel 202 when the metering tray 218 is mounted on the coin separating and sorting assembly.

Included on the metering tray is a first tab 296 that protrudes from the second end wall 286. The tray 216 also includes a second tab 298 that protrudes from the first extension 288. The metering tray 216 also includes a foot 300 protruding downwardly from a base of the tray. The foot 300 can help stabilize the metering tray on the wheel housing 200.

In use, coins are dropped onto the metering tray 216, either onto the ramp 278 or onto the floor 276. Coins that fall onto the ramp 278 are urged toward the floor 276 by gravity. As best shown in FIG. 13, the metering tray is situated on the wheel housing 200 such that coins on the floor 276 are urged toward the opening 284 by gravity. The opening is sized so as to allow only one coin to pass from the metering tray 216 onto the separating wheel 202. Included in separating wheel 202 are a plurality of coin separating apertures 252 into which the coins can fall. As the coin separating wheel 202 rotates, it is unobstructed by the coin metering tray 216 because the tray is raised above the wheel 202 due to the foot 300 and the second end wall 286. This can perhaps best be seen in FIG. 20. If a coin separating aperture 252 happens to pick up more than one coin, as the coin separating wheel moves in a clockwise direction, the tab 298 has a lower end spaced from the wheel such that it precludes multiple coins from traveling in one aperture by knocking off the coin that resides on top of the other. After being picked up in the aperture 252 of the separating wheel, the coins travel a very similar path as that already described with reference to the embodiment of FIGS. 1-8.

In an alternate embodiment, the tab 298 can mount to the housing or the hopper 204. Even as so mounted, the tab 298 would still serve its purpose of precluding more than one coin from residing is a coin receiving aperture 252, but it need not be mounted to or be part of the metering tray 216.

While only one embodiment of a metering tray was described, it should be appreciated that other embodiments are contemplated by the invention. For example, the metering tray need not have the shape of floor illustrated. Furthermore, the metering tray does not need to have a ramp to urge the coins towards the opening. Thus, the metering tray should not be limited to the shape depicted in the drawings. As stated earlier, the metering device regulates delivery of coins to the coin separating and sorting assembly to reduce the likelihood of unwanted jamming of the assembly.

The coin metering tray was described in combination with the coin sorting and separating assembly of FIGS. 9-20, however the coin metering tray can be used with other coin sorting and separating assemblies. For example, the metering tray could be used with the coin sorting and separating assembly described in FIGS. 1-8 or it could be used with other known coin sorting and separating mechanisms where it would be beneficial to meter, regulate, or limit the speed with which coins are delivered to a coin sorting and separating assembly.

The invention as been described with reference to several embodiments. Obviously, modifications and alterations will occur to others upon a reading and understanding of the preceding written description. It is intended that the invention be construed as including all such modifications and alterations insofar as they come within the scope of the appended claims and the equivalents thereof.

What is claimed is:

1. A coin bank comprising:
a housing;
a coin separating member including at least one coin receiving aperture;
a coin sorting member on which said coin separating member is movably supported, said coin sorting member including at least one coin sorting aperture, said coin sorting member being mounted to said housing; and
a metering tray supported by said housing and positioned adjacent said coin separating member, wherein said metering tray regulates the number of associated coins delivered to said coin separating member.

2. The coin bank of claim 1, wherein said metering tray comprises a plurality of walls and an opening, said opening having a width dimensioned to allow only one largest diameter associated coin meant to be sorted by said coin sorting member to pass at a time from said metering tray to said coin separating member.

3. The coin bank of claim 1, wherein said metering tray comprises a plurality of walls and an opening, wherein said opening is smaller than the combined diameter of two of the smallest diameter ones of the associated coins meant to be sorted by said coin sorting member.

4. The coin bank of claim 1, further comprising a hopper and wherein said metering tray is mounted to said hopper.

5. The coin bank of claim 1, further comprising a hopper and said metering tray includes a wall having a channel that receives a portion of said hopper.

6. The coin bank of claim 1, wherein said metering tray includes a ramp that urges the associated coins that land on said ramp towards an adjacent floor.

7. The coin bank of claim 6, wherein said metering tray includes a wall that is positioned adjacent an end of said ramp to preclude the associated coins from moving directly from said ramp to said coin separating member.

8. The coin bank of claim 1, further comprising a tab to preclude more than one of the associated coins from residing in said at least one coin receiving aperture, said tab being mounted to one of said housing, said metering tray and a hopper.

9. The coin bank of claim 1, wherein said coin separating member includes a toroidal flange extending away from a face of said coin separating member, said toroidal flange including at least one protuberance adjacent said at least one coin receiving aperture.

10. A coin bank comprising:
a housing;
a coin separating member including at least one coin receiving aperture;
a coin sorting member on which said coin separating member is supported, said coin sorting member including at least one coin sorting aperture and being mounted to said housing;
a coin slide mounted to said housing below said coin sorting member; and
a tray mounted to said housing above said coin sorting member, said tray including walls and an opening which limits the number of associated coins passing from said tray to said coin separating member.

11. The coin bank of claim 10, wherein said opening in said tray has a width smaller than the combined diameter of two of the smallest diameter associated coins meant to be sorted by said coin sorting member.

12. The coin bank of claim 10, wherein at least one of said walls of said tray comprises a substantially parabolic shape.

13. The coin bank of claim 12, wherein said tray includes a ramp having an edge that terminates adjacent a floor, wherein said edge and at least a portion of one of said walls defines a chute having a width substantially equal to the width of said opening.

14. The coin bank of claim 10, wherein said coin-sorting member includes at least one coin sorting aperture having a first width that is dimensioned to allow passage of a first diameter associated coin and a second width that is dimensioned to allow passage of a second diameter associated coin.

15. The coin bank of claim 10, wherein said coin separating member includes a flange extending away from a face of said coin separating member and a projection on said flange proximal said at least one coin receiving aperture.

16. The coin bank of claim 15, wherein said coin separating member comprises a wheel.

17. The coin bank of claim 10, wherein said tray comprises a tab, said tab having an end located adjacent said coin separating member so as to preclude more than one of the associated coins from residing in said coin receiving aperture as said aperture moves past said tab.

18. A metering tray for metering the number of associated coins delivered to a coin separating member of an associated coin bank, said metering tray comprising a plurality of walls defining an opening that limits the number of associated coins exiting said metering tray at any given time.

19. A coin separating and sorting assembly comprising:
a separating wheel including at least one coin receiving aperture, a toroidal flange extending away from a face of said separating wheel and a protuberance on said toroidal flange proximal said at least one coin receiving aperture; and
a wheel housing on which said separating wheel is rotatably supported.

20. The assembly of claim 19, wherein said at least one coin receiving aperture extends from an inner periphery of the separating wheel to said toroidal flange.

21. The assembly of claim 19, wherein said protuberance is positioned toward a leading edge of said at least one coin receiving aperture.

22. The assembly of claim 19, wherein said wheel housing defines a coin sorting aperture having a first width adapted to allow passage of associated coins of a first diameter and a second width adapted to allow passage of associated coins of a second diameter.

23. A metering tray for metering a number of associated coins delivered to a coin separating member of a coin bank, said metering tray comprising:
a first side wall;
a second side wall spaced from said first side wall;
a first end wall connecting said first and second side walls;
a floor extending between, and connected to, said first end wall and said second side wall;
an aperture defined in said floor;
a ramp extending between and connected to said floor and said first side wall; and
a blocking wall connected to a first side edge of said ramp and to said first side wall, wherein said blocking wall prevents associated coins in the tray from sliding off said ramp and onto said coin separating member of said coin bank.

24. The tray of claim 23 wherein said first end wall is curved.

25. The tray of claim 23 wherein said floor angles downwardly from said first end wall towards said aperture.

26. The tray of claim 25 wherein said ramp is longer adjacent said first side edge thereof than it is adjacent a second side edge thereof.

27. The tray of claim 23 wherein the associated coins range from a smallest diameter coin to a largest diameter coin and a width of said floor is so dimensioned as to allow only one of the largest diameter coins to rest on said floor adjacent said aperture.

28. The tray of claim 27 wherein the width of said floor is so dimensioned as to be smaller than the combined diameters of two of the smallest diameter coins.

29. The tray of claim 23 further comprising a second end wall secured to said first and second side walls.

30. The tray of claim 29 further comprising a first tab extending away from said second end wall.

31. The tray of claim 29 further comprising a first extension leading from said first side wall to said second end wall and a second extension leading from said second side wall to said second end wall.

32. The tray of claim 31 further comprising a second tab protruding from said first extension.

33. The tray of claim 29 wherein said second end wall comprises a U-shaped channel.

34. The tray of claim 23 further comprising a stabilizing member protruding away from a bottom surface of said floor.

35. The tray of claim 23 wherein the tray is of one piece and comprises a thermoplastic material.
